(19) United States
(12) Patent Application Publication
(10) Pub. No.: US 2021/0284102 A1
(43) Pub. Date: Sep. 16, 2021

(54) SYSTEM AND METHOD FOR CLEANING A SENSOR LENS

(71) Applicant: GM GLOBAL TECHNOLOGY OPERATIONS LLC, Detroit, MI (US)

(72) Inventors: Sai Vishnu Aluru, Commerce Township, MI (US); Michael D. Alarcon, Markham (CA)

(21) Appl. No.: 16/814,143

(22) Filed: Mar. 10, 2020

(51) Int. Cl. B60S 1/60; B08B 7/02; B08B 3/04; B08B 5/02; B60S 1/48; B60S 1/54

(52) U.S. Cl. CPC B60S 1/603; B08B 7/028; B60S 1/54; B08B 5/02; B60S 1/481; B08B 3/04

(57) ABSTRACT

A lens-cleaning assembly includes an ultrasonic cleaning system configured to selectively generate vibrations in a lens. The ultrasonic cleaning system is operable to selectively generate cleaning vibrations at a plurality of pulse widths. The cleaning system also includes a controller in communication with the ultrasonic cleaning system. The controller is configured to automatically determine a target pulse width among the plurality of pulse widths in response to a detected characteristic of a detected occlusion on the lens, and to automatically control the ultrasonic cleaning system to generate a cleaning vibration having the target pulse width.

### INTRODUCTION

The present disclosure relates generally to sensor cleaning, and more particularly to cleaning sensors for motor vehicles.

Motor vehicles may be provided with one or more sensors, including optical cameras such as backup cameras. Motor vehicles capable of autonomous driving may be provided with additional sensor types, including RADAR and LiDAR arrays. Such sensors generally have lenses through which signals are transmitted and/or received. However, during operation in a variety of environmental conditions, water, dirt, and other debris may accumulate on the sensor lenses.

### SUMMARY

An automotive vehicle according to the present disclosure includes a sensor configured to receive a signal. The vehicle also includes a lens having a first face and a second face. The first face is disposed proximate the sensor, and the second face is exterior-facing. The lens is arranged to pass the signal from the second face to the sensor. The vehicle additionally includes an ultrasonic cleaning system configured to selectively generate vibrations in the lens. The ultrasonic cleaning system is operable to selectively generate cleaning vibrations at a plurality of pulse widths. The vehicle further includes a controller in communication with the sensor and the ultrasonic cleaning system. The controller is configured to determine a target pulse width among the plurality of pulse widths in response to a detected characteristic of a detected occlusion in the signal, and to control the ultrasonic cleaning system to generate a cleaning vibration having the target pulse width.

In an exemplary embodiment, the ultrasonic cleaning system is further configured to selectively generate vibrations at a plurality of magnitudes, and the controller is further configured to determine a target magnitude among the plurality of magnitudes in response to the detected characteristic of the detected occlusion in the signal and to control the ultrasonic cleaning system to generate a cleaning vibration having the target magnitude.

In an exemplary embodiment, the vehicle additionally includes a fluid cleaning system configured to provide cleaning fluid to the second face. In such an embodiment, the controller is further configured to selectively control the fluid cleaning system to provide cleaning fluid in response to the detected characteristic of the detected occlusion in the signal.

In an exemplary embodiment, the vehicle additionally includes a compressed air cleaning system configured to provide compressed air to the second face. In such an embodiment, the controller is further configured to selectively control the compressed air cleaning system to provide compressed air in response to the detected characteristic of the detected occlusion in the signal.

A lens-cleaning assembly according to the present disclosure includes an ultrasonic cleaning system configured to selectively generate vibrations in a lens. The ultrasonic cleaning system is operable to selectively generate cleaning vibrations at a plurality of pulse widths. The cleaning assembly also includes a controller in communication with the ultrasonic cleaning system. The controller is configured to automatically determine a target pulse width among the plurality of pulse widths in response to a detected characteristic of a detected occlusion on the lens, and to automatically control the ultrasonic cleaning system to generate a cleaning vibration having the target pulse width.

In an exemplary embodiment, the ultrasonic cleaning system is further configured to selectively generate vibrations at a plurality of magnitudes, and the controller is further configured to automatically determine a target magnitude among the plurality of magnitudes in response to the detected characteristic of the detected occlusion and to automatically control the ultrasonic cleaning system to generate a cleaning vibration having the target magnitude.

In an exemplary embodiment, the lens-cleaning assembly additionally includes a fluid cleaning system configured to provide cleaning fluid, and the controller is further configured to selectively control the fluid cleaning system to provide cleaning fluid in response to the detected characteristic of the detected occlusion.

In an exemplary embodiment, the lens-cleaning assembly additionally includes a compressed air cleaning system configured to provide compressed air, and the controller is further configured to selectively control the compressed air cleaning system to provide compressed air in response to the detected characteristic of the detected occlusion.

A method of cleaning a lens according to the present disclosure includes providing a sensor configured to receive a signal. The sensor has a lens. The method also includes providing an ultrasonic cleaning system configured to selectively generate vibrations in the lens. The ultrasonic cleaning system is operable to selectively generate cleaning vibrations at a plurality of pulse widths. The method additionally includes providing a controller in communication with the sensor and the ultrasonic cleaning system. The method further includes, in response to a detected characteristic of a detected occlusion on the lens, automatically determining, via the controller, a target pulse width among the plurality of pulse widths. The method further includes automatically controlling the ultrasonic cleaning system, via the controller, to generate a cleaning vibration having the target pulse width.

In an exemplary embodiment, the ultrasonic cleaning system is further configured to selectively generate vibrations at a plurality of magnitudes. In such embodiments, the method includes, in response to the detected characteristic of the detected occlusion, automatically determining, via the controller, a target magnitude among the plurality of magnitudes. The method additionally includes automatically controlling, via the controller, the ultrasonic cleaning system to generate a cleaning vibration having the target magnitude.

In an exemplary embodiment, the method also includes providing a fluid cleaning system configured to provide cleaning fluid to the lens. In such an embodiment, the method additionally includes, in response to the detected characteristic of the detected occlusion, automatically controlling the fluid cleaning system to provide cleaning fluid.

In an exemplary embodiment, the method also includes providing a compressed air cleaning system configured to provide compressed air to the lens. In such an embodiment, the method additionally includes, in response to the detected characteristic of the detected occlusion, automatically controlling the compressed air cleaning system to provide compressed air.

Embodiments according to the present disclosure provide a number of advantages. For example, systems and methods according to the present disclosure may provide effective cleaning of lenses while reducing the energy and fluid usage required for cleaning operations.

The above advantage and other advantages and features of the present disclosure will be apparent from the following detailed description of the preferred embodiments when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a schematic representation of an automotive vehicle system according to an embodiment of the present disclosure;

FIG. 2 is a schematic representation of a cleaning assembly according to an embodiment of the present disclosure;

FIG. 3 is a flowchart representation of a method of controlling a vehicle according to a first embodiment of the present disclosure; and

FIG. 4 is a flowchart representation of a method of controlling a vehicle according to a second embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

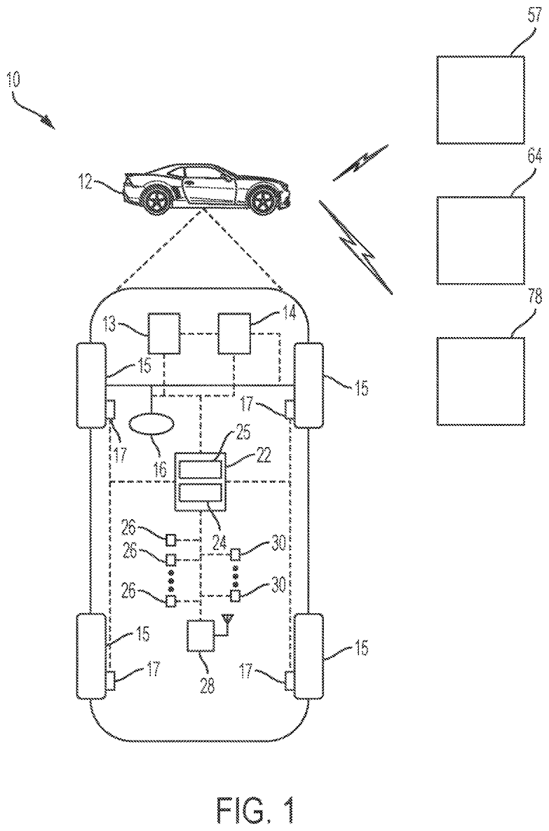

FIG. 1 schematically illustrates an operating environment that comprises a mobile vehicle communication and control system 10 for a motor vehicle 12. As discussed herein, the vehicle 12 includes a variety of sensors 26 that provide information to assist with control of the vehicle 12. The sensors 26 include, in some embodiments, one or more RADAR, LIDAR, optical cameras, thermal cameras, ultrasonic sensors, and/or additional sensors as appropriate. The field of view or vision of a LIDAR, RADAR, optical camera, or other sensor may be compromised in inclement weather driving conditions by condensation, precipitation, or debris on the lens of the sensor. Sensor cleaning methods and systems discussed herein are used to mitigate issues related to compromised fields of view by cleaning and analyzing the sensors' fields of view.

Cleaning systems for lenses may make use of ultrasonic cleaning systems. In such systems, vibrations are generated in the lens which may remove debris, as will be discussed in further detail below. Known ultrasonic cleaning systems generate vibrations having fixed frequencies, magnitudes, and pulse widths. While such systems may be effective, they may also consume more energy than is required to remove a given article of debris. As will be discussed in further detail below, systems and methods according to the present disclosure may vary the vibrations generated in the lens to effect more efficient debris removal.

The vehicle 12, shown schematically in FIG. 1, includes a propulsion system 13, which may in various embodiments include an internal combustion engine, an electric machine such as a traction motor, and/or a fuel cell propulsion system. Vehicle 12 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 includes a wireless communication system 28 configured to wirelessly communicate with other vehicles (“V2V”) and/or infrastructure (“V2I”). In an exemplary embodiment, the wireless communication system 28 is configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor such as a central processing unit (CPU) or graphics processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In some embodiments, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

The controller 22 also includes a sensor evaluation and cleaning control system 25 for automatically detecting, analyzing, and classifying occlusions and other irregularities in the lens of the sensor 26. As discussed herein, the sensors 26 include RADAR, LIDAR, optical cameras, and/or additional sensors for which a clear field of view improves the function of the sensor.

FIG. 1 illustrates several networked devices that can communicate with the wireless communication system 28 of the vehicle 12. One of the networked devices that can communicate with the vehicle 12 via the wireless communication system 28 is the networked wireless device 57. The networked wireless device 57 can include computer processing capability, a transceiver capable of communicating using a short-range wireless protocol, and a visual display. The computer processing capability includes a microprocessor in the form of a programmable device that includes one or more instructions stored in an internal memory structure and applied to receive binary input to create binary output. In some embodiments, the networked wireless device 57 includes a GPS module capable of receiving GPS satellite signals and generating GPS coordinates based on those signals. In other embodiments, the networked wireless device 57 includes cellular communications functionality such that the networked wireless device 57 carries out voice and/or data communications over a wireless carrier system using one or more cellular communications protocols.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the networked wireless device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12.

The remote access center 78 is designed to provide the wireless communication system 28 of the vehicle 12 with a number of different system functions and generally includes one or more databases, live advisors, as well as an automated voice response system (VRS). These various remote access center components are preferably coupled to one another via a wired or wireless local area network. The databases can store account information such as subscriber authentication information, vehicle identifiers, profile records, behavioral patterns, sensor status data, and other pertinent subscriber information. Data transmissions may also be conducted by wireless systems, such as 802.11x, GPRS, and the like. The remote access center 78 can utilize the VRS as an automated advisor, or a combination of the VRS and the live advisor can be used.

It should be understood that the disclosed methods can be used with any number of different systems and is not specifically limited to the operating environment shown here. The architecture, construction, setup, and operation of the system 10 and its individual components is generally known. Other systems not shown here and known to those skilled in the art could employ the disclosed methods as well.

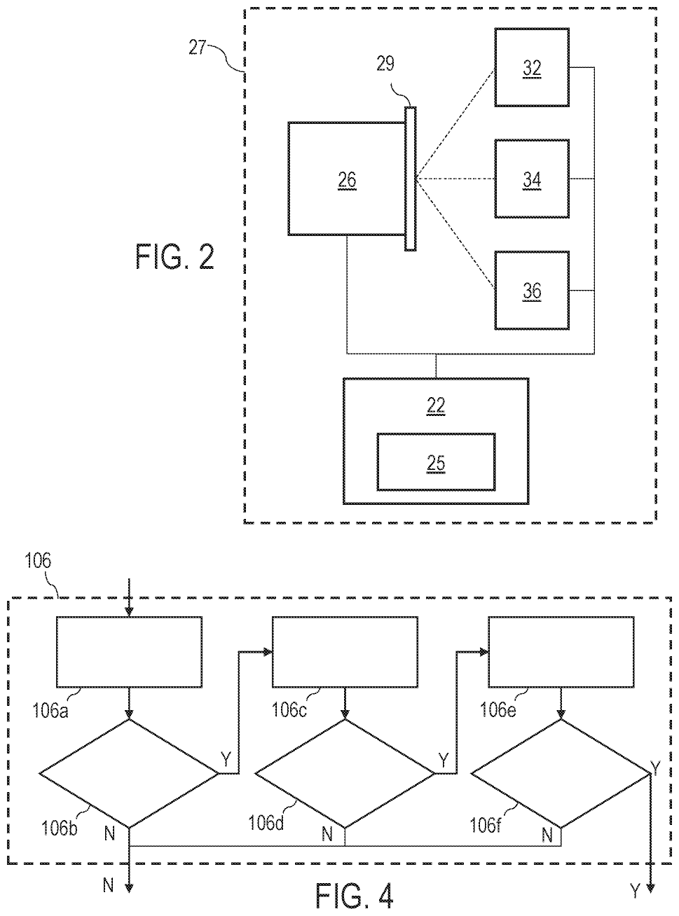

FIG. 2 schematically illustrates a lens-cleaning assembly 27 for a lens 29 of one of the sensors 26. The lens 29 comprises a transmissive body configured to transmit a signal between a first face proximate the sensor 26 and a second face disposed at the exterior of the vehicle 12. According to the type of sensor 26, the lens 29 may be configured to transmit visible light, infrared radiation, ultraviolet radiation, or other suitable portion of the frequency spectrum.

The lens-cleaning assembly 27 includes a first lens-cleaning system 32, a second lens-cleaning system 34, and a third lens-cleaning system 36. The first lens-cleaning system 32 has a first cleaning modality, the second lens-cleaning system 34 has a second cleaning modality, and the third lens-cleaning system 36 has a third cleaning modality. As used herein, the phrase “cleaning modality” means a process, technique or method for attempting to remove or reduce the amount of debris or other contaminant present on the lens 29. Non-limiting examples of cleaning modalities utilized by the present disclosure include pressurized air, pressurized fluid, and ultrasonic vibration.

In an exemplary embodiment the first lens-cleaning system 32 is configured as an ultrasonic cleaning system. In such systems, an actuator, e.g. a piezoelectric vibrating element, is coupled to the lens 29 and configured to generate ultrasonic vibrations in the lens 29.

In an exemplary embodiment the second lens-cleaning system 34 is configured as a fluid cleaning system. Such systems are configured to spray pressurized cleaning fluid on the lens 29.

In an exemplary embodiment the third lens-cleaning system 36 is configured as a compressed air cleaning system. Such systems are configured to apply a high-pressure blast of air to the lens 29.

The first lens-cleaning system 32, second lens-cleaning system 34, and third lens-cleaning system 36 are in communication with or under control of the controller 22.

While only a single lens-cleaning assembly 27 is shown for illustrative purposes, one of ordinary skill in the art will appreciate that the vehicle 12 may include a plurality of lens-cleaning assemblies 27 for a corresponding plurality of lenses 29 of the sensors 26.

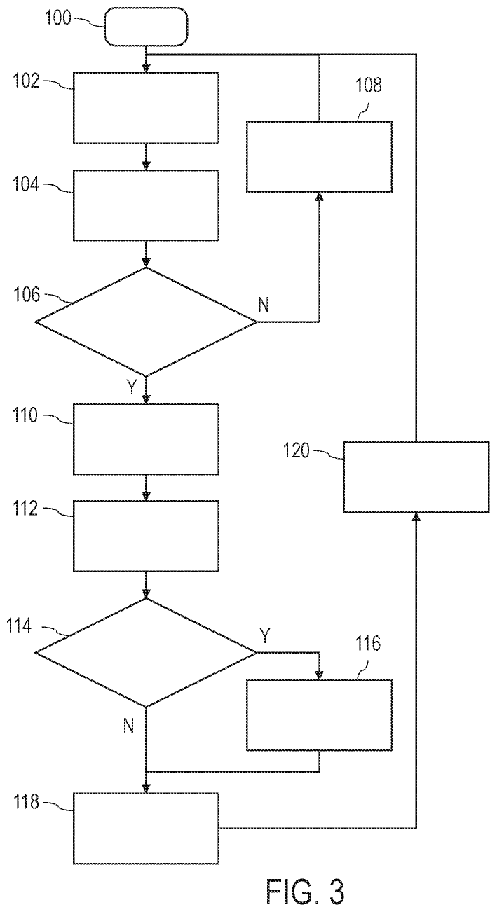

Referring now to FIG. 3, a method of controlling a cleaning assembly according to the present disclosure is illustrated in flowchart form. In an exemplary embodiment, the method is performed by control of a lens cleaning assembly, e.g. the assembly 27, via a controller, e.g. the controller 22. One or more aspects of the method may be performed by the cleaning control system 25. The method begins at block 100, e.g. at the beginning of a drive cycle.

A signal is acquired, as illustrated at block 102. The signal is acquired via one of the sensors 26. In the exemplary embodiment where the sensor 26 is an optical camera, the acquired signal is an optical image. However, in other embodiments utilizing other sensor types, other signal types may be acquired, e.g. a RADAR return signal, LiDAR return signal, etc.

The signal is processed, as illustrated at block 104. In the exemplary embodiment where the sensor 26 is an optical camera, the image processing may include one or more of an automatic white balance, an image tone map, an image histogram, an image quality statistics analysis, and an edge contour analysis. As will be appreciated by one of ordinary skill in the art, in embodiments utilizing other sensor types, other signal processing may be implemented as appropriate for a given signal type.

A determination is made of whether an occlusion is present, as illustrated at operation 106. An occlusion may be caused by liquid, dirt, or other debris on the lens 29. Operation 106 is illustrated in further detail in FIG. 4 for an exemplary embodiment where the sensor 26 is an optical camera and the acquired signal is an optical image. As will be appreciated by one of ordinary skill in the art, in embodiments using other sensor types, the determination of operation 106 may be based upon other analytical factors.

The acquired image is scanned for closed edge contours, as illustrated at block 106a. The presence of closed edge contours may be indicative of the presence of an occlusion positioned extremely close to the sensor 26, e.g. disposed on the lens 29.

A determination is made of whether closed edge contours are present, as illustrated at operation 106b. In response to the determination being negative, operation 106 terminates with a negative determination.

In response to the determination of operation 106b being positive, the size and location of the occluded region are determined and a contrast is evaluated between the occluded region and the non-occluded region of the image, as illustrated at block 106c. The size and contrast of the occluded region may indicate the composition of the debris causing the occlusion, while the location may enable more precisely targeting cleaning.

A determination is made of whether the contrast is reduced at the occluded region relative to the non-occluded region of the image, as illustrated at operation 106d. In response to the determination being negative, operation 106 terminates with a negative determination.

In response to the determination of operation 106d being positive, the occluded region is scanned for static pixels, as illustrated at block 106e.

A determination is made of whether static pixels are present in the occluded region, as illustrated at block 106f. In response to the determination of operation 106f being negative, operation 106 terminates with a negative determination. In response to the determination of operation 106f being positive, operation 106 terminates with a positive determination.

Returning to FIG. 3, in response to the determination of operation 106 being negative, active cleaning operations (if any) are discontinued, as illustrated at block 108. Control subsequently returns to block 102.

In response to the determination of operation 106 being positive, ultrasonic cleaning parameters are determined, as illustrated at block 110. In various exemplary embodiments, the parameters include pulse width, pulse magnitude, or both. In other embodiments, other ultrasonic cleaning parameters may be used in addition to or in place of pulse width and pulse magnitude.

The ultrasonic cleaning parameters may be determined based on characteristics of the occluded region evaluated in operation 106, including, but not limited to, the size, contrast, and location of the occluded region, and the color, position, and size of any static pixels in the occluded region. Various combinations of characteristics are indicative of liquid, dirt, or other types of debris, each of which may require different cleaning parameters for effective cleaning.

In an exemplary embodiment, the cleaning control system 25 is configured to obtain the ultrasonic cleaning parameters from a lookup table stored in nontransient data storage in communication with the controller 22. In such an embodiment, the lookup table contains values for the ultrasonic cleaning parameters, e.g. pulse width and pulse magnitude, as functions of the aforementioned characteristics of the occluded region. Such a lookup table may be established based on experimentation, simulation, or other suitable method.

The pulse width and frequency for ultrasonic cleaning are subsequently multiplexed, as illustrated at block 112, to produce a final ultrasonic cleaning signal.

A determination is then made of whether one or more additional cleaning modalities are desired, as illustrated at operation 114. As discussed above, the additional cleaning modalities may include fluid cleaning, compressed air, or other suitable cleaning modalities. In an exemplary embodiment, this determination is obtained from a lookup table. In some such embodiments, a single lookup table is provided containing the values for ultrasonic cleaning parameters as well as for additional cleaning modalities based on the aforementioned characteristics of the occluded region.

In response to the determination of operation 114 being positive, i.e. one or more additional cleaning modalities being desired, then the selected modality or modalities is/are activated, as illustrated at block 116. Control then proceeds to block 118. In response to the determination of operation 114 being negative, control proceeds directly to block 118.

The cleaning assembly is then controlled to perform a cleaning operation with the selected parameters, i.e. the parameters for ultrasonic cleaning along with any additional cleaning modalities, as illustrated at block 118. The cleaning operation will be performed, e.g. by coordination of one or more of the lens-cleaning systems 32, 34, 36 by the controller 22, to attempt to remove the debris from the lens 29.

In an optional step, an escalated diagnostic may be performed, as illustrated at block 120. The escalated diagnostic may include, for example, communicating an alert to an occupant within the vehicle 12 and/or communicating an alert to one or more of the networked wireless device 57, computer 64, and the remote access center 78. The escalated diagnostic may be conditionally performed, e.g. upon repeated cleaning attempts which do not effectively reduce or eliminate the debris.

Control then returns to block 102. The algorithm may thereby iterate, modifying the ultrasonic cleaning parameters and the use or disuse of additional cleaning modalities as needed.

As may be seen, the present disclosure provides effective cleaning of sensor lenses while reducing the energy and fluid usage required for cleaning operations.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. An automotive vehicle comprising:
a sensor configured to receive a signal;
a lens having a first face and a second face, the first face being disposed proximate the sensor, the second face being exterior-facing, the lens being arranged to pass the signal from the second face to the sensor;
an ultrasonic cleaning system configured to selectively generate vibrations in the lens, the ultrasonic cleaning system being operable to selectively generate cleaning vibrations at a plurality of pulse widths; and
a controller in communication with the sensor and the ultrasonic cleaning system, the controller being configured to determine a target pulse width among the plurality of pulse widths in response to a detected characteristic of a detected occlusion in the signal, and to control the ultrasonic cleaning system to generate a cleaning vibration having the target pulse width.

2. The vehicle of claim 1, wherein the ultrasonic cleaning system is further configured to selectively generate vibrations at a plurality of magnitudes, and wherein the controller is further configured to determine a target magnitude among the plurality of magnitudes in response to the detected characteristic of the detected occlusion in the signal and to control the ultrasonic cleaning system to generate a cleaning vibration having the target magnitude.

3. The vehicle of claim 1, further comprising a fluid cleaning system configured to provide cleaning fluid to the second face, wherein the controller is further configured to selectively control the fluid cleaning system to provide cleaning fluid in response to the detected characteristic of the detected occlusion in the signal.

4. The vehicle of claim 1, further comprising a compressed air cleaning system configured to provide compressed air to the second face, wherein the controller is further configured to selectively control the compressed air cleaning system to provide compressed air in response to the detected characteristic of the detected occlusion in the signal.

5. A lens-cleaning assembly comprising:
an ultrasonic cleaning system configured to selectively generate vibrations in a lens, the ultrasonic cleaning system being operable to selectively generate cleaning vibrations at a plurality of pulse widths; and
a controller in communication with the ultrasonic cleaning system, the controller being configured to automatically determine a target pulse width among the plurality of pulse widths in response to a detected characteristic of a detected occlusion on the lens, and to automatically control the ultrasonic cleaning system to generate a cleaning vibration having the target pulse width.

6. The lens-cleaning assembly of claim 5, wherein the ultrasonic cleaning system is further configured to selectively generate vibrations at a plurality of magnitudes, and wherein the controller is further configured to automatically determine a target magnitude among the plurality of magnitudes in response to the detected characteristic of the detected occlusion and to automatically control the ultrasonic cleaning system to generate a cleaning vibration having the target magnitude.

7. The lens-cleaning assembly of claim 5, further comprising a fluid cleaning system configured to provide cleaning fluid, wherein the controller is further configured to selectively control the fluid cleaning system to provide cleaning fluid in response to the detected characteristic of the detected occlusion.

8. The lens-cleaning assembly of claim 5, further comprising a compressed air cleaning system configured to provide compressed air, wherein the controller is further configured to selectively control the compressed air cleaning system to provide compressed air in response to the detected characteristic of the detected occlusion.

9-12. (canceled)
